(19) United States
(12) Patent Application Publication
(10) Pub. No.: US 2024/0348559 A1
(43) Pub. Date: Oct. 17, 2024

(54) INTEGRATION OF RESERVATION AND NON-RESERVATION ROUTING PROTOCOLS WITHIN THE SAME NETWORK

(71) Applicant: Cisco Technology, Inc., San Jose, CA (US)

(72) Inventors: Christian Schmutzer, Koenigsbrunn im Wein (AT); Francois Clad, Horbourg-Wihr (FR); Stephane Litkowski, Liffre (FR)

(73) Assignee: Cisco Technology, Inc., San Jose, CA (US)

(21) Appl. No.: 18/357,029

(22) Filed: Jul. 21, 2023

Related U.S. Application Data
(60) Provisional application No. 63/458,497, filed on Apr. 11, 2023.

(51) Int. Cl. H04L 47/726; H04L 45/50; H04L 45/52

(52) U.S. Cl. CPC H04L 47/726; H04L 45/50; H04L 45/52

(57) ABSTRACT

Techniques for enabling a resource reservation routing protocol (e.g., the Resource Reservation Protocol-Traffic Engineering (RSVP-TE) protocol) to perform routing operations based at least in part on bandwidth reservations by a non-reservation protocol (e.g., the Segment Routing (SR) protocol) are described herein. In some cases, the techniques described herein enable an example network to use both a resource reservation protocol and a non-reservation protocol. In some cases, one or more bandwidth reservation measures associated with a label-switched path (LSP) associated with a non-reservation protocol (e.g., an SR LSP) are used to create LSPs associated with a resource reservation protocol (e.g., RSVP-TE LSPs).

### CROSS-REFERENCE TO RELATED APPLICATION

The present application claims priority to U.S. Provisional Patent Application No. 63/458,497, entitled “Co-existence of Bi-directional Segmented Routing and Resource Reservation Protocol-Traffic Engineering (RSVP-TE) Paths,” filed on Apr. 11, 2023, which is incorporated by reference herein in its entirety.

### TECHNICAL FIELD

This present application pertains to the field of computer networking and more specifically, to techniques for routing protocols.

### BACKGROUND

Modern networks face the challenge of efficiently managing diverse traffic flows while ensuring optimal reservation of network resources and meeting Quality of Service (QOS) requirements. Traditional routing protocols, such as Resource Reservation Protocol-Traffic Engineering (RSVP-TE), focus on resource reservation to guarantee bandwidth and QoS commitments for specific traffic flows. However, the emergence of Segment Routing (SR) as a flexible routing paradigm introduces new opportunities for network optimization and traffic engineering without the need for complex signaling protocols and state in the network.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 provides an example architecture for a network that enables both RSVP-TE routing and SR.

FIG. 2 is a flowchart diagram of an example process for exchanging bandwidth reservation data associated with a SR plane onto an RSVP-TE plane.

FIG. 3A provides an operational example of RSVP-TE bandwidth reservations across an example network.

FIG. 3B provides an operational example of SR bandwidth reservations across the example network of FIG. 3A.

FIG. 3C provides an operational example of RSVP-TE bandwidth reservations across the example network of FIGS. 3A-3B after integration of SR bandwidth reservations into the RSVP-TE space.

FIG. 4 is a flowchart diagram of an example process for determining the RSVP-TE bandwidth reservation amount of a network link.

FIG. 5 is a flowchart diagram of an example process for performing RSVP-TE routing using SR bandwidth reservation measurement data.

FIG. 6 illustrates a block diagram illustrating an example packet switching device (or system) that can be utilized to implement various aspects of the technologies disclosed herein.

FIG. 7 shows an example computer architecture for a computing device (or network routing device) capable of executing program components for implementing the functionality described above.

### DESCRIPTION OF EXAMPLE EMBODIMENTS

### Overview

Techniques for improving the resiliency and reliability of service insertion using dynamic service path selection are described herein. In some aspects, the techniques described herein relate to a method including: identifying a first label-switched path (LSP) record associated with a first protocol, wherein: (i) the first protocol is a non-reservation routing protocol, and (ii) the first LSP record is associated with a first LSP that uses a first link and a second link in a network; determining a first bandwidth reservation measure for the first link in relation to the first protocol; determining a second bandwidth reservation measure for the second link in relation to the first protocol; storing a second LSP record associated with a second protocol, wherein: (i) the second protocol is a reservation routing protocol, (ii) the second LSP record represents a third bandwidth reservation measure that is determined based on the first bandwidth reservation measure, and (iii) the second LSP record is associated with a second LSP that comprises the first link; storing a third LSP record associated with the second protocol, wherein the third LSP record: (i) represents a represents a fourth bandwidth reservation measure that is determined based on the second bandwidth reservation measure, and (iii) is associated with a third LSP that comprises the second link; and determining a path associated with the second protocol based on the second LSP and the third LSP.

Additionally, the techniques described herein may be performed by a system and/or device having non-transitory computer-readable media storing computer-executable instructions that, when executed by one or more processors, performs the method described above.

### Example Embodiments

The techniques described herein relate to enabling a resource reservation routing protocol (e.g., the Resource Reservation Protocol-Traffic Engineering (RSVP-TE) protocol) to perform routing operations based at least in part on bandwidth reservations by a non-reservation protocol (e.g., the Segment Routing (SR) protocol). The techniques described herein enable the network to use both a resource reservation protocol and a non-reservation protocol. While various implementations described herein discuss co-existence of a single resource reservation protocol and a single non-reservation protocol within the same network, a person of ordinary skill in the relevant technology will recognize that the techniques described herein can be used to enable co-existence of any number of resource reservation protocols and non-reservation protocols.

In some cases, one or more bandwidth reservation measures associated with a label-switched path (LSP) associated with a non-reservation protocol (e.g., an SR LSP) are used to create LSPs associated with a resource reservation protocol (e.g., RSVP-TE LSPs). For example, if a first LSP associated with a non-reservation protocol includes a first network link and a second network link, then an example system may: (i) a second LSP associated with the resource reservation protocol that includes the first link and whose bandwidth reservation amount is determined based on the bandwidth reservation measure for the first network link, and (ii) a third LSP associated with the non-reservation protocol that includes the second link and whose bandwidth reservation amount is determined based on the bandwidth reservation measure for the second network link. In some cases, the second LSP and the third LSP are one-link LSPs, such that the second LSP only includes the first network link and the second LSP only includes the second network link.

As described above, in some cases, the techniques described herein enable co-existence of at least one resource reservation protocol and at least one non-reservation protocol within the same network. A resource reservation protocol may be a routing protocol that enables explicit reservation of network resources along a specific path for a particular traffic flow. An example of a resource reservation protocol is RSVP-TE. In some cases, RSVP-TE enables the reservation of network resources such as bandwidth, buffer space, and/or other Quality of Service (QOS) parameters required for a specific traffic flow.

In some cases, RSVP-TE establishes a dedicated path for that flow, ensuring that the necessary resources are available along the path to meet the desired QoS requirements. In some cases, RSVP-TE utilizes signaling messages exchanged between network nodes to establish and maintain the reserved path. These signaling messages may carry information about the desired QoS parameters, the path to be taken, and the resources to be reserved. The reservation process may involve a series of messages, including Path messages, which are sent to determine the path, and Resv messages, which are used to reserve the necessary resources along the path. A primary objective of RSVP-TE may be to provide Quality of Service (QOS) guarantees for specific traffic flows. In some cases, by reserving network resources along the path, RSVP-TE ensures that the traffic receives the desired treatment, such as guaranteed bandwidth, low latency, or low packet loss, according to the requested QoS parameters.

A non-reservation protocol may be a routing protocol that accomplishes selection of a path for traffic flow without explicit reservation of resources along the selected path. An example of a non-reservation protocol is the SR protocol. In some cases, SR defines a path for a packet that is a sequence of network segments. In some cases, SR operates by using existing routing protocols, such as the Interior Gateway Protocol (IGP) or the Border Gateway Protocol (BGP), to compute the optimal paths in the network. The routing information may then be used to derive a set of segments that define the desired path for the traffic. These segments can be based on topology, policy, and/or service requirements. In some cases, the source node encapsulates the packet with the segment list, and intermediate nodes in the network follow the instructions provided by the segments to forward the packet along the predetermined path.

In some cases, SR provides network operators with enhanced control and flexibility, enabling them to steer traffic efficiently, optimize resource reservation, and dynamically adapt to changing network conditions without requiring complex signaling protocols or per-flow state information within the network.

In some cases, the techniques described herein enable the coexistence of a resource reservation protocol (such as RSVP-TE) and a non-reservation protocol (like SR) within a network. In some cases, using bandwidth reservation measures associated with non-reservation protocol LSPs, new LSPs associated with the resource reservation protocol can be created. For example, if an SR LSP includes multiple network links, the system can generate separate one-link RSVP-TE LSPs, each associated with a specific network link of the SR LSP. The bandwidth reservation amount for each RSVP-TE LSP can be determined based on the corresponding bandwidth reservation measure of the SR LSP (or LSPs) on this link. This approach allows for more granular control over resource allocation and facilitates the integration of reservation and non-reservation protocols in the network.

In some cases, the techniques described herein enable a reservation protocol, such as RSVP-TE, to make more informed traffic flow selections by using information from non-reservation protocols like SR. These techniques may provide the reservation protocol with insights into the bandwidth reservation and characteristics of traffic flows within the network. By considering the bandwidth reservation measures associated with SR LSPs, the reservation protocol can use information about the existing traffic load and resource availability at specific network links. This information allows the reservation protocol to make more informed decisions when selecting traffic flows to establish and allocate resources. For example, if certain network links involved in SR LSPs exhibit high bandwidth reservation, the reservation protocol can take this into account and prioritize other traffic flows that require lower bandwidth or have different QoS requirements. By avoiding congested or heavily utilized paths, the reservation protocol can optimize the distribution of resources and increase the likelihood that the desired QOS for each traffic flow is ensured. Accordingly, in some cases, techniques described herein enhance the intelligence and adaptability of the reservation protocol, enabling it to dynamically respond to network conditions and make traffic flow selections based on real-time information. This may improve overall network performance, maximize resource reservation, and enhance the ability of the reservation protocol to provide optimal QoS guarantees for different types of network traffic.

In some cases, the techniques described herein provide a comprehensive approach to integrating SR and RSVP-TE within a network. In some cases, the techniques described herein enhance the coordination between SR and RSVP-TE by leveraging SR bandwidth reservation measurements to optimize RSVP-TE routing decisions and resource allocation.

In some cases, an example process starts by identifying SR LSPs in the network and determining the network links associated with them. The bandwidth reservation measure for each link is then computed, considering the traffic flowing through the SR LSPs. This data serves as a valuable input for determining the appropriate bandwidth reservation in RSVP-TE. Based on the bandwidth reservation data, one-hop RSVP-TE LSPs are created for the network links associated with SR LSPs. These LSPs represent dedicated paths with specific bandwidth allocations. RSVP-TE LSP records are stored, capturing relevant information about the created LSPs. Path selection for RSVP-TE is performed by considering the newly stored RSVP-TE LSP records, enabling optimal routing decisions based on bandwidth reservations and other factors.

In some cases, integrating SR bandwidth reservation measurements into RSVP-TE, the techniques described herein provide a more accurate representation of the network's resource reservation and enable optimized resource allocation for both SR and RSVP-TE traffic. This approach ensures efficient reservation of network resources, better QoS guarantees, and improved traffic engineering capabilities. The seamless coexistence of SR and RSVP-TE allows networks to benefit from the flexibility and scalability of SR while leveraging the resource reservation capabilities of RSVP-TE.

In some cases, the techniques described herein provide a comprehensive approach to integrating SR and RSVP-TE within a network. These techniques focus on enhancing the coordination between SR and RSVP-TE by leveraging SR bandwidth reservation measurements to optimize RSVP-TE routing decisions and resource allocation. The techniques introduce several key concepts and operations to achieve this integration. They highlight the coexistence of both reservation and non-reservation protocols within the same network and emphasize the ability to utilize bandwidth reservation measures from non-reservation protocols like SR to inform RSVP-TE routing decisions.

By incorporating SR bandwidth reservation measurements, the techniques enable RSVP-TE to gain insights into the actual resource reservation and characteristics of traffic flows within the network. This allows the reservation protocol to make more informed decisions when selecting traffic flows, establishing reservations, and allocating resources. By considering the bandwidth reservation measures associated with SR LSPs, RSVP-TE can optimize the distribution of resources, prioritize traffic flows based on real-time information, and ensure optimal QOS guarantees for different types of network traffic forwarded by the network.

In some cases, the techniques described herein provide a detailed process for integrating SR and RSVP-TE. This includes identifying SR LSPs in the network, determining the associated network links, computing bandwidth reservation measures, creating one-hop RSVP-TE LSPs based on the SR-associated links, storing RSVP-TE LSP records, and performing path selection considering the newly stored LSP records. These operations enable efficient resource allocation, optimized routing decisions, and improved traffic engineering capabilities within the network.

In some cases, the techniques described herein offer a comprehensive solution to seamlessly integrate SR and RSVP-TE, leveraging the benefits of both reservation and non-reservation protocols. By combining the advantages of these protocols and utilizing SR bandwidth reservation measurements, the network can achieve enhanced resource reservation, improved QoS provisioning, and efficient traffic management.

In some cases, by enabling the coexistence of resource reservation and non-reservation protocols, the techniques provide network operators with greater flexibility and control over their networks. They allow for the seamless integration of different routing mechanisms, each offering unique advantages, while ensuring efficient resource reservation and adherence to QoS requirements. The reservation of bandwidth reservation measures associated with non-reservation protocols enables more informed decision-making, dynamic traffic flow selection, and effective resource allocation within the network.

In some cases, the techniques described herein provide a comprehensive framework for integrating RSVP-TE and SR, facilitating the coexistence of reservation and non-reservation protocols within the same network. By leveraging bandwidth reservation measures, network operators can optimize resource allocation, enhance traffic engineering capabilities, and achieve optimal QoS guarantees for different types of traffic flows. These techniques contribute to the efficient and intelligent management of network resources, ultimately leading to improved network performance, reliability, and scalability.

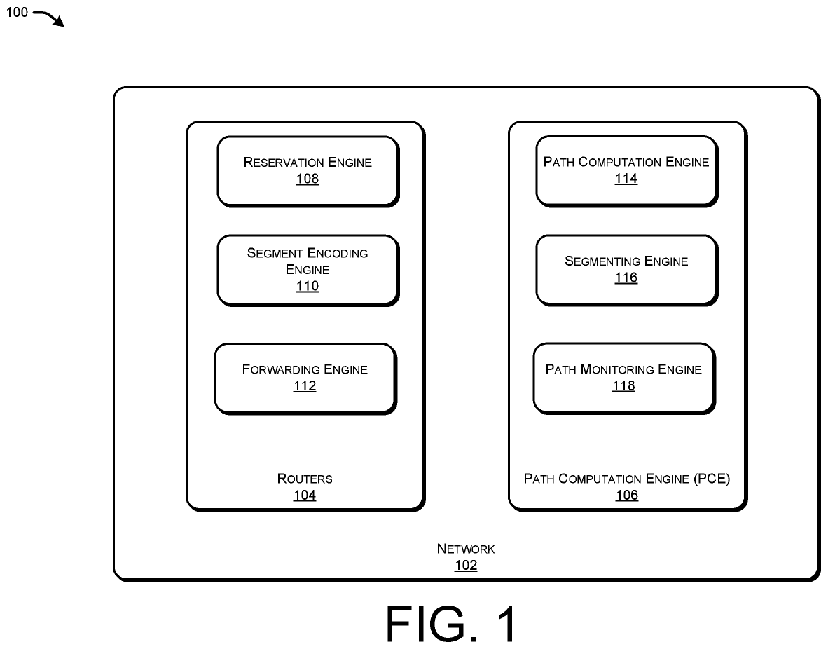

FIG. 1 provides an example architecture 100 for a network 102 that enables both RSVP-TE routing and SR. As depicted in FIG. 1, network 102 includes a set of routers 104 and a path computation engine (PCE) 106. Each router 104 may be associated with a reservation engine 108, a segment encoding engine 110, and a forwarding engine 112. PCE 106 may be associated with a path computation engine 114, a segmenting engine 116, and a path monitoring engine 118.

The reservation engine 108 may be configured to enable RSVP-TE on those interfaces of a corresponding router 104 that participate in traffic engineering. The reservation engine 108 may further be configured to configure the router's RSVP-TE parameters such as timers, bandwidth constraints, and/or QoS settings. The reservation engine 108 may further be configured to exchange signals with other routers in the network 102 to establish and/or deactivate RSVP-TE sessions. The reservation engine 108 may process RSVP-TE messages received from other routers and update the local RSVP-TE state of the corresponding router 104 accordingly. The reservation engine 108 may be configured to receive a request for a traffic-engineered path and, in response, calculate and reserve necessary network resources based on the RSVP-TE signaling messages exchanged.

The segment encoding engine 110 may be configured to define SR-related parameters, such as the SR algorithm, segment identifier (SID) mappings, and/or SR policies. The segment encoding engine 110 may further be configured to encode packets with SIDs based on the defined SR policies. In some cases, SIDs can be mapped to instructions that determine the packet forwarding behavior within the network 102.

The forwarding engine 112 may be configured to forward packets. In some cases, when a packet is being routed using RSVP-TE, forwarding the packet includes forwarding the packet along the next-hop in the path reserved for the packet. In some cases, when a packet is being routed using SR, the packet is forwarded to a next-hop as determined based on the SIDs encoded into the packet's header.

The path computation engine 114 may be configured to compute RSVP-TE paths based on the network topology, resource availability, and/or TE constraints. In some cases, to compute an RSVP-TE path, the path computation engine 114 uses data received from the routers 104, such as link state information. The path computation engine 114 may further be configured to communicate RSVP-TE paths to routers. For example, the path computation engine 114 may communicate an RSVP-TE path using the Path Computation Element Protocol (PCEP). In some cases, to communicate an RSVP-TE path, the path computation engine 114 sends path setup requests to the routers 104, instructing them to establish the RSVP-TE sessions and reserve resources along the computed paths.

The segmenting engine 116 may be configured to assign SIDs to network nodes and links based on the desired segment routing policy and network topology. The segmenting engine 116 may determine optimal SID values and their associations with network elements. The segmenting engine 116 may further be configured to determine a path for a packet routed using SR. The path may be a sequence of segments and/or a sequence of SIDs for forwarding the packet. In some cases, after the segmenting engine 116 has computed an SR path, the segmenting engine 116 communicates with the routers 104 (e.g., using PCEP) to provide instructions to the routers 104 on how to set up the segment routing paths and configure the SID-based forwarding.

The path monitoring engine 118 may be configured to monitor and/or update the network, including at least one of the RSVP-TE paths and/or the SR paths determined as a sequence of SIDs and/or a sequence of segments. In some cases, if the path monitoring engine 118 detects that there are changes in network conditions or traffic demands that require path recomputing and/or that affect optimality of existing recommended paths, the path monitoring engine 118 can recompute paths and send updated instructions to the routers 104 for path adjustments and/or resource reservations.

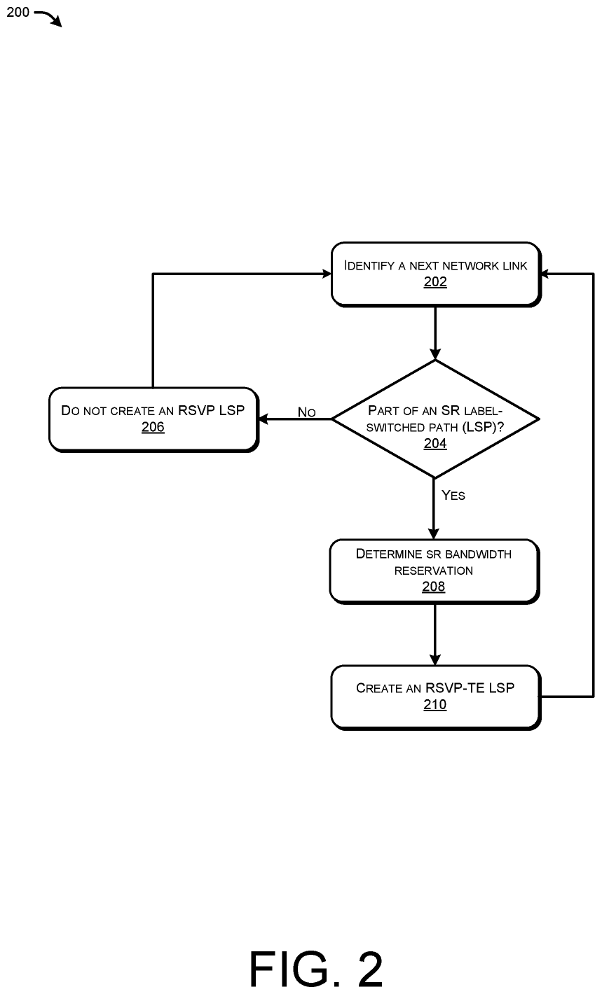

FIG. 2 is a flowchart diagram of an example process 200 for exchanging bandwidth reservation data associated with a SR plane onto an RSVP-TE plane. As depicted in FIG. 2, at operation 202, process 200 includes identifying a network link. A network link may be a physical and/or logical connection between two nodes (e.g., two routers) in a network.

At operation 204, process 200 includes determining whether the identified network link is part of an SR LSP. In some cases, a network link is part of an SR LSP if at least one packet that is being routed using SR is transmitted using the network link. If the identified network link is determined not to be part of an SR LSP at operation 204, the process 200 proceeds to operation 206. At operation 206, process 200 includes skipping the creation of an RSVP-TE LSP for the identified network link and proceeding to identify a next network link that has not been processed.

If the identified network link is determined to be part of an SR LSP at operation 204, the process 200 proceeds to operation 208. At operation 208, process 200 includes determining bandwidth reservation data associated with the identified network link. This data may include a bandwidth reservation measure about the amount of bandwidth currently being utilized by the SR traffic flowing through the identified network link. In some cases, the bandwidth reservation measure is determined based on the bandwidth reservation amounts associated with the network link across all of the SR LSPs that use the network link.

In some cases, the calculation of bandwidth reservation for a link used in SR depends on the specific implementation and monitoring mechanisms employed within the network. For example, some network devices maintain interface counters that track the number of packets and/or bytes transmitted or received on a specific interface. By periodically sampling these counters, the rate of data transmission can be determined. Dividing this rate by the link's capacity can provide an estimation of the bandwidth reservation.

As another example, some network monitoring systems employ flow-based monitoring techniques, such as NetFlow or Internet Protocol Flow Information Export (IPFIX), to track individual traffic flows within the network. By examining the flow records associated with the SR LSP, including the source and destination IP addresses, ports, and protocol, it is possible to estimate the bandwidth consumed by the SR flow on the link. The accuracy of bandwidth reservation calculations can vary based on factors such as the granularity of monitoring, the frequency of sampling, and the resolution of flow records.

After determining the bandwidth reservation data for the identified network link at operation 208, the process proceeds to operation 210. At operation 210, process 200 includes creating an RSVP-TE LSP for the identified network link based on the bandwidth reservation data for the identified network link. The created RSVP-TE LSP may be an RSVP-TE that includes (e.g., that solely includes) the identified network link. In some cases, the bandwidth reservation amount for the created RSVP-TE LSP is determined based on the bandwidth reservation data for the identified network link as determined at operation 208. In some cases, after operation 210, process 200 returns to operation 202 to identify a next network link that has not been processed.

In some cases, the purpose of creating RSVP-TE LSPs that reflect bandwidth reservation data associated with the SR plane is to exchange usage data between the RSVP-TE plane and the SR plane. The purpose of exchanging the bandwidth reservation data from the SR plane to the RSVP-TE plane may be to provide insights and information about the traffic flow and resource reservation by the SR LSP. By sharing this data, the RSVP-TE plane can make more informed decisions regarding resource reservation, traffic engineering, and path selection.

In some cases, exchanging the bandwidth reservation data from the SR plane to the RSVP-TE plane enables the RSVP-TE protocol to consider the actual bandwidth usage of the SR LSP when making resource allocation decisions, ensuring efficient reservation of network resources and better overall routing performance.

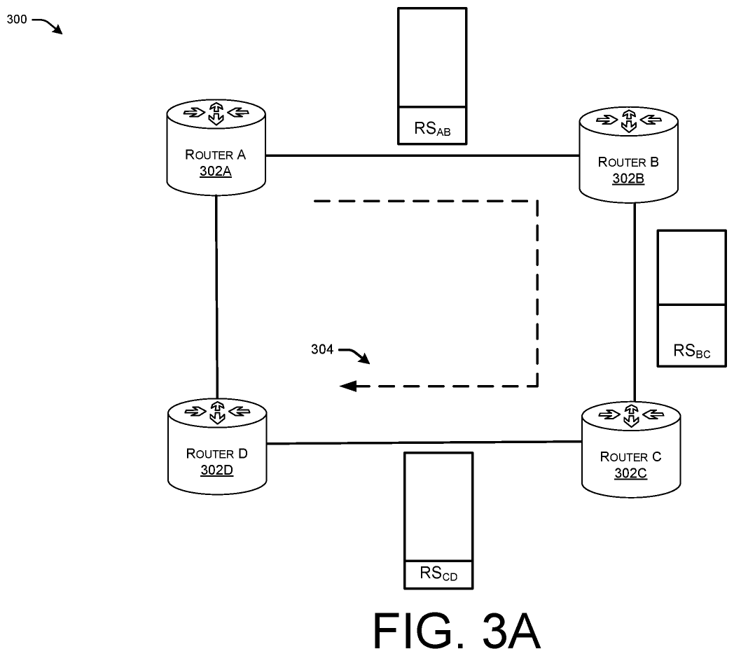

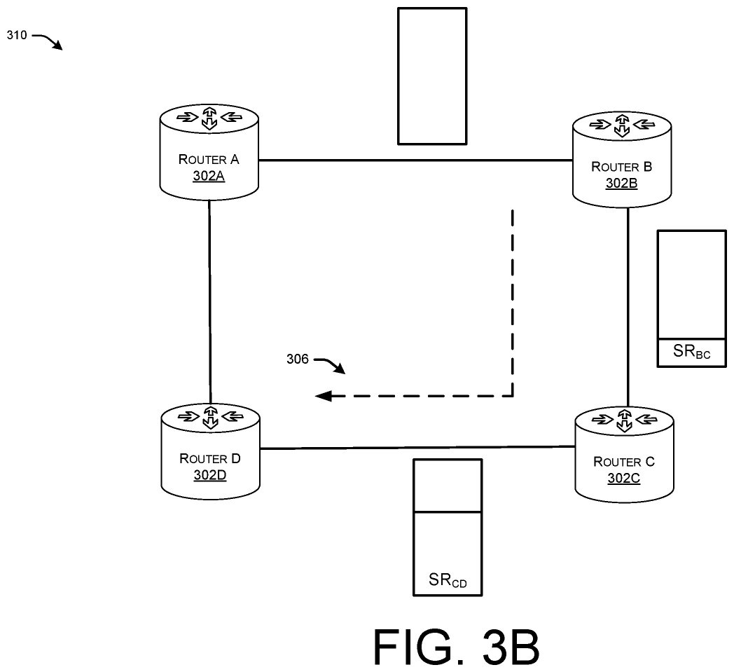

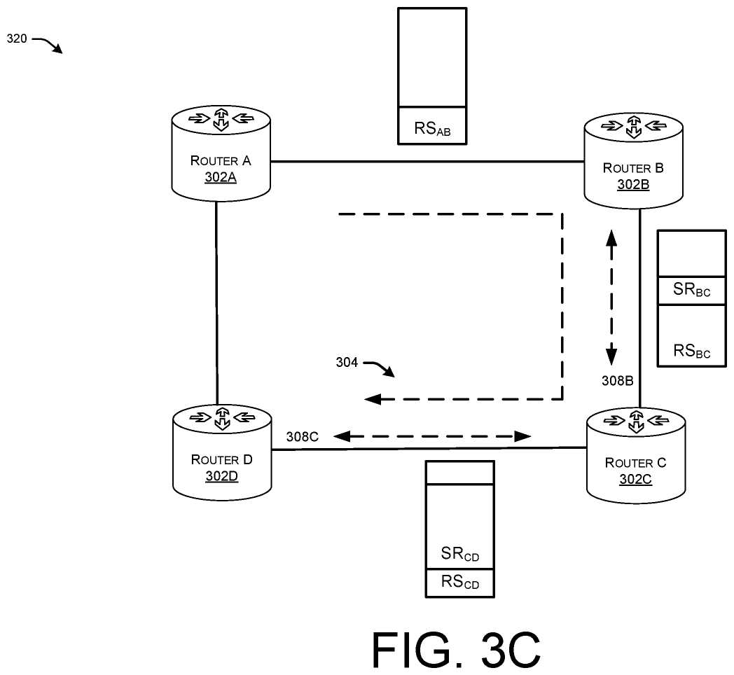

FIG. 3A provides an operational example 300 of RSVP-TE bandwidth reservations across an example network. As depicted in FIG. 3A, the network includes a link AB between a router A 302A and a router B 302B, a link BC between the router B 302B and a router C 302C, a link CD between the router C 302C and a router D 302D, and a link AD between router A 302A and router D 302D. As further depicted in FIG. 3A, the link AB is associated with an RSVP-TE bandwidth reservation amount of RS_{AB}, the link BC is associated with an RSVP-TE bandwidth reservation amount of RS_{BC}, and the link CD is associated with an RSVP-TE bandwidth reservation amount of RS_{CD}. FIG. 3A also depicts that the RSVP-TE plane includes a multi-hop LSP 304.

FIG. 3B provides an operational example 310 of SR bandwidth reservations across the example network of FIG. 3A. As depicted in FIG. 3B, the link AB is not associated with an SR bandwidth reservation, the link BC is associated with an SR bandwidth reservation SR_{BC}, and the link CD is associated with an SR bandwidth reservation SR_{CD}. FIG. 3B also depicts that the SR plane includes a multi-hop LSP 306.

FIG. 3C provides an operational example 320 of RSVP-TE bandwidth reservations across the example network of FIGS. 3A-3B. FIG. 3C also depicts that, in addition to the multi-hop LSP 304, the RSVP-TE plane includes four one-hop LSPs 308B-308C.

As depicted in FIG. 3C, the RSVP-TE bandwidth reservations for the link BC are updated to add a one-hop RSVP-TE LSP with the bandwidth reservation of SR_{BC} and thus the RSVP-TE bandwidth reservation of that link now equals RS_{BC}+SR_{BC}.

Furthermore, the RSVP-TE bandwidth reservations for the link CD are updated to add a one-hop RSVP-TE LSP with the bandwidth reservation of SR_{CD} and thus the RSVP-TE bandwidth reservation of that link now equals RS_{CD}+SR_{CD}.

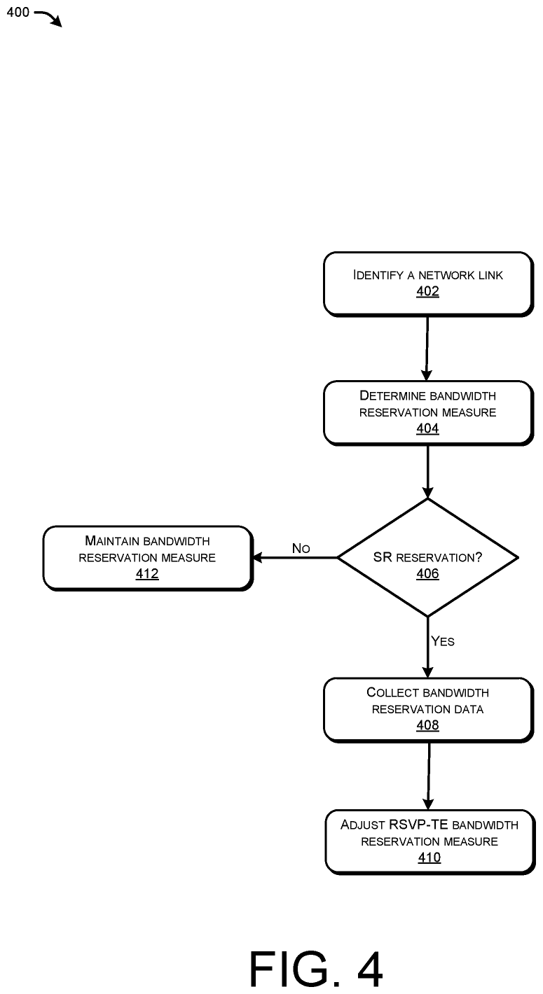

FIG. 4 is a flowchart diagram of an example process 400 for determining the RSVP-TE bandwidth reservation amount of a network link. Process 400 may be performed to generate data used for RSVP-TE path computation and/or data forwarded across routers in a network. As depicted in FIG. 4, at operation 402, process 400 includes identifying a network link. A network link may be a physical and/or logical connection between two nodes (e.g., two routers) in a network.

At operation 404, process 400 includes determining the RSVP-TE bandwidth reservation measure for the identified network link. In some cases, the RSVP-TE bandwidth reservation measure represents all of the reservations of the bandwidth associated with the identified network link across all of the RSVP-TE LSPs that are associated with the identified network link.

At operation 406, process 400 includes determining whether the identified network link is used for SR. In some cases, a link is determined to be used for SR if the link is associated with at least one SR LSP. If, at operation 404, it is determined that the identified network link is not used for SR, process 400 proceeds to operation 412 and the RSVP-TE bandwidth reservation measure for the identified network link is not adjusted.

If, at operation 406, it is determined that the identified network link is indeed used for SR, the process proceeds to operation 408. At operation 408, process 400 includes collecting bandwidth reservation data specifically for the identified network link in relation to the SR LSPs associated with it. This data represents the amount of bandwidth utilized by the traffic flowing through the SR LSPs that utilize the identified network link. In some cases, the calculation of bandwidth reservation for a link used in SR depends on the specific implementation and monitoring mechanisms employed within the network.

After collecting the bandwidth reservation data at operation 408, the process continues to operation 410 At operation 410, process 400 includes adjusting the RSVP-TE bandwidth reservation measure for the identified network link based on (e.g., by adding) the SR bandwidth reservation measure for the identified network link. Adjusting the RSVP-TE bandwidth reservation measure based on the SR bandwidth reservation measure may ensure that the overall bandwidth reservation accurately reflects the combined reservation of the network link by both RSVP-TE and SR traffic flows. By incorporating the SR bandwidth reservation measure, the RSVP-TE bandwidth reservation can be adjusted to consider the shared usage of the network link by the two routing mechanisms.

In some cases, the adjustment made at operation 410 ensures that the RSVP-TE bandwidth reservation measure reflects the total bandwidth requirements of the identified network link, considering the bandwidth allocations from both the RSVP-TE LSPs and the SR LSPs associated with it. This allows for effective resource management and optimization, as well as maintaining QoS guarantees for both types of traffic. The specific method of adjusting the RSVP-TE bandwidth reservation measure may vary depending on the implementation. It could involve adding the SR bandwidth reservation directly to the existing RSVP-TE reservation or using a weighted calculation to determine the appropriate adjustment. The adjustment process ensures that the RSVP-TE bandwidth reservation measure accurately accounts for the bandwidth needs of the network link, considering the coexistence of both RSVP-TE and SR traffic flows.

In some cases, the adjusted RSVP-TE reservation amount, which takes into account the bandwidth reservation by SR protocol, may play an important role in RSVP-TE routing. It may be utilized in path computation to determine a suitable path that considers the total bandwidth requirements of both RSVP-TE and SR traffic. The adjusted reservation amount guides path selection by incorporating the link's actual bandwidth usage from both routing mechanisms. During resource reservation, using the adjusted reservation amount may ensure the allocation of sufficient bandwidth along the selected path to meet the QoS requirements of both traffic types. Additionally, the adjusted reservation amount may enable effective traffic engineering strategies, such as load balancing, congestion management, and dynamic reservation adjustments, based on the link's capacity reservation by RSVP-TE and SR traffic.

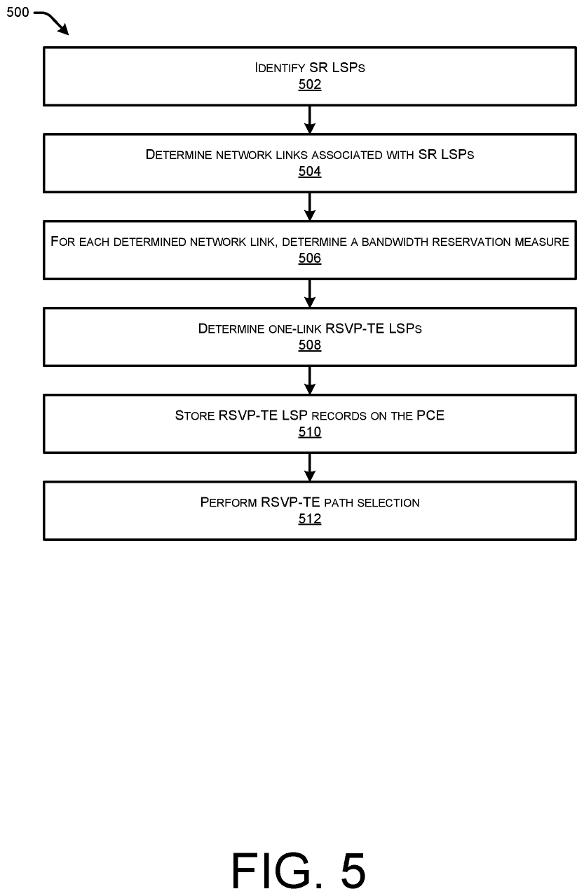

FIG. 5 is a flowchart diagram of an example process 500 for performing RSVP-TE routing using SR bandwidth reservation measurement data. As depicted in FIG. 5, at operation 502, process 500 includes identifying a set of SR LSPs in the network. Each SR LSP may be associated with an SR LSP record that represents data associated with the SR LSP. The SR LSP may be encoded in the header of packets forwarded using the SR LSP, may be maintained in SR policy data maintained by routers, and/or may be maintained in SR policy data maintained by a centralized SR management component such as PCE.

At operation 504, process 500 includes determining network links associated with the identified SR LSPs. A network link may be associated with an SR LSP if the network is used for packet forwarding using the SR LSP. In some cases, an SR LSP represents a sequence of segments and can be used to determine a set of links/hops within the described segments.

At operation 506, process 500 includes determining a bandwidth reservation measure for each network link that is determined to be associated with at least one identified SR LSP. A link's bandwidth reservation measure may reflect the amount of bandwidth used by SR traffic flow through the link.

At operation 508, process 500 includes creating a one-hop RSVP-TE LSP associated with each network link that is determined to be associated with at least one identified SR LSP. A one-hop RSVP-TE LSP may be an RSVP-TE who is associated with a single link. In some cases, the bandwidth reservation amount for a one-hop RSVP-TE LSP is determined based on the SR bandwidth reservation measure associated with the corresponding network link.

At operation 510, process 500 includes storing an RSVP-TE LSP record for the created one-hop RSVP-TE LSP. In some cases, RSVP-TE LSP records maintain relevant information regarding the newly established LSPs, including the link associated with each LSP and its corresponding bandwidth reservation details.

At operation 512, process 500 includes performing RSVP-TE path selection based on the set of RSVP-TE LSP records includes the newly-stored RSVP-TE LSP. In some cases, a PCE performs RSVP-TE path selection based on the set of RSVP-TE LSP records, which now includes the newly stored RSVP-TE LSPs. Using the available records, the path selection algorithm of the PCE can make informed decisions, considering factors such as bandwidth reservations, QoS requirements, and network topology, to determine the optimal path for RSVP-TE traffic flow.

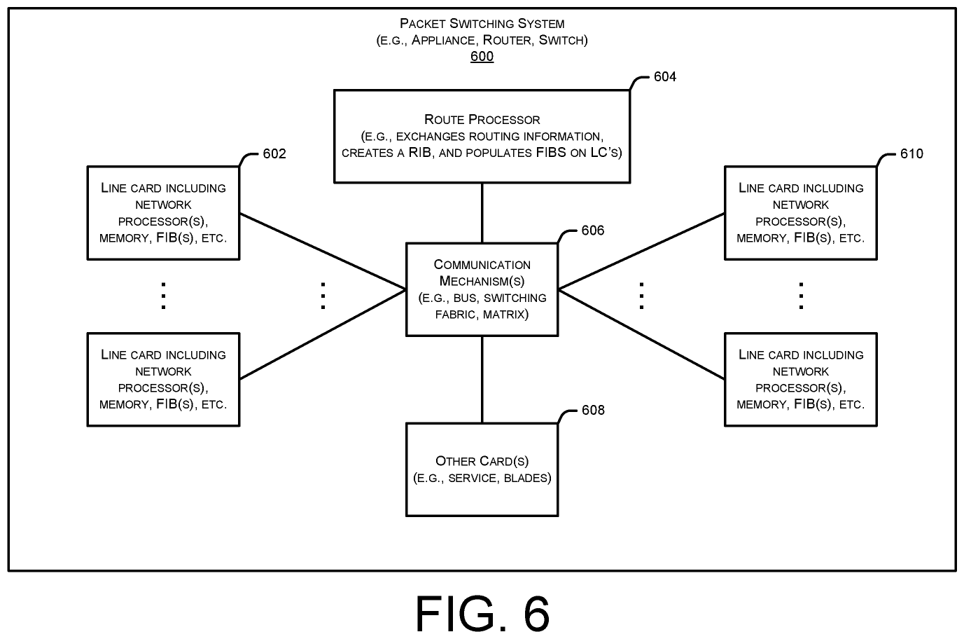

FIG. 6 illustrates a block diagram illustrating an example packet switching device (or system) 600 that can be utilized to implement various aspects of the technologies disclosed herein. In some examples, packet switching device(s) 600 may be employed in various networks, such as an SDWAN. The packet switching device may, for example, be a branch router or an edge router.

In some examples, a packet switching device 600 may comprise multiple line card(s) 602, 610, each with one or more network interfaces for sending and receiving packets over communications links (e.g., possibly part of a link aggregation group). The packet switching device 600 may also have a control plane with one or more processing elements 606 for managing the control plane and/or control plane processing of packets associated with forwarding of packets in a network. The packet switching device 600 may also include other cards 608 (e.g., service cards, blades) which include processing elements that are used to process (e.g., forward/send, drop, manipulate, change, modify, receive, create, duplicate, apply a service) packets associated with forwarding of packets in a network. The packet switching device 600 may comprise hardware-based communication mechanism 606 (e.g., bus, switching fabric, and/or matrix, etc.) for allowing its different entities 602, 604, 608 and 610 to communicate. Line card(s) 602, 610 may typically perform the actions of being both an ingress and/or an egress line card 602, 610, in regard to multiple other particular packets and/or packet streams being received by, or sent from, packet switching device 600.

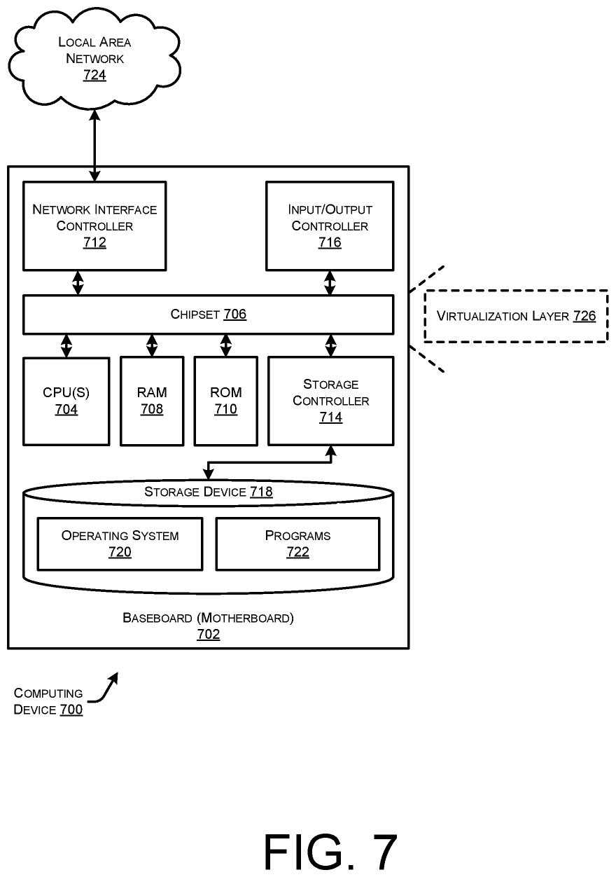

FIG. 7 shows an example computer architecture for a computing device (or network routing device) 700 capable of executing program components for implementing the functionality described above. The computer architecture shown in FIG. 7 illustrates a conventional server computer, workstation, desktop computer, laptop, tablet, network appliance, e-reader, smartphone, or other computing device, and can be utilized to execute any of the software components presented herein.

The computing device 700 includes a baseboard 702, or “motherboard,” which is a printed circuit board to which a multitude of components or devices can be connected by way of a system bus or other electrical communication paths. In one illustrative configuration, one or more central processing units (“CPUs”) 704 operate in conjunction with a chipset 706. The CPUs 704 can be standard programmable processors that perform arithmetic and logical operations necessary for the operation of the computing device 700.

The CPUs 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 706 provides an interface between the CPUs 704 and the remainder of the components and devices on the baseboard 702. The chipset 706 can provide an interface to a RAM 708, used as the main memory in the computing device 700. The chipset 706 can further provide an interface to a computer-readable storage medium such as a read-only memory (“ROM”) 710 or non-volatile RAM (“NVRAM”) for storing basic routines that help to startup the computing device 700 and to transfer information between the various components and devices. The ROM 710 or NVRAM can also store other software components necessary for the operation of the computing device 700 in accordance with the configurations described herein.

The computing device 700 can operate in a networked environment using logical connections to remote computing devices and computer systems through a network, such as the network 724. The chipset 706 can include functionality for providing network connectivity through a NIC 712, such as a gigabit Ethernet adapter. The NIC 712 is capable of connecting the computing device 700 to other computing devices over the network 724. It should be appreciated that multiple NICs 712 can be present in the computing device 700, connecting the computer to other types of networks and remote computer systems.

The computing device 700 can be connected to a storage device 718 that provides non-volatile storage for the computing device 700. The storage device 718 can store an operating system 720, programs 722, and data, which have been described in greater detail herein. The storage device 718 can be connected to the computing device 700 through a storage controller 714 connected to the chipset 706. The storage device 718 can consist of one or more physical storage units. The storage controller 714 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 700 can store data on the storage device 718 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 718 is characterized as primary or secondary storage, and the like.

For example, the computing device 700 can store information to the storage device 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 700 can further read information from the storage device 718 by detecting the physical states or characteristics of one or more particular locations within the physical storage units.

In addition to the mass storage device 718 described above, the computing device 700 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 700.

In some examples, the operations performed by a network, and/or any components included therein (e.g., a router, such as an edge router), may be supported by one or more devices similar to computing device 700. Stated otherwise, some or all of the operations performed by the network, and or any components included therein, may be performed by one or more computing device 700 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 718 can store an operating system 720 utilized to control the operation of the computing device 700. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 718 can store other system or application programs and data utilized by the computing device 700.

In one embodiment, the storage device 718 or other computer-readable storage media is encoded with computer-executable instructions which, when loaded into the computing device 700, transform the computer from a general-purpose computing system into a special-purpose computer capable of implementing the embodiments described herein. These computer-executable instructions transform the computing device 700 by specifying how the CPUs 704 transition between states, as described above. According to one embodiment, the computing device 700 has access to computer-readable storage media storing computer-executable instructions which, when executed by the computing device 700, perform the various processes described above with regard to FIGS. 2-5. The computing device 700 can also include computer-readable storage media having instructions stored thereupon for performing any of the other computer-implemented operations described herein.

The computing device 700 can also include one or more input/output controllers 716 for receiving and processing input from a number of input devices, such as a keyboard, a mouse, a touchpad, a touch screen, an electronic stylus, or other type of input device. Similarly, an input/output controller 716 can provide output to a display, such as a computer monitor, a flat-panel display, a digital projector, a printer, or other type of output device. It will be appreciated that the computing device 700 might not include all of the components shown in FIG. 7, can include other components that are not explicitly shown in FIG. 7, or might utilize an architecture completely different than that shown in FIG. 7.

The computing device 700 may support a virtualization layer 726, such as one or more components associated with a computing resource network. The virtualization layer 726 may provide virtual machines or containers that abstract the underlying hardware resources and enable multiple operating systems or applications to run simultaneously on the same physical machine.

The virtualization layer 726 may also include components for managing the virtualized resources, such as a hypervisor or virtual machine manager, and may provide network virtualization capabilities, such as virtual switches, routers, or firewalls. By enabling the sharing and efficient utilization of physical resources, virtualization can help reduce costs, simplify management, and increase flexibility in deploying and scaling computing workloads. The computing device 700 may also support other software layers, such as middleware, application frameworks, or databases, that provide additional abstraction and services to application developers and users. In some cases, the computing device 700 may provide a flexible and scalable platform for hosting diverse workloads and applications, from simple web services to complex data analytics and machine learning tasks.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
identifying a first label-switched path (LSP) record associated with a first protocol, wherein: (i) the first protocol is a non-reservation routing protocol, and (ii) the first LSP record is associated with a first LSP that uses a first link and a second link in a network;
determining a first bandwidth reservation measure for the first link in relation to the first protocol;
determining a second bandwidth reservation measure for the second link in relation to the first protocol;
storing a second LSP record associated with a second protocol, wherein: (i) the second protocol is a reservation routing protocol, (ii) the second LSP record represents a third bandwidth reservation measure that is determined based on the first bandwidth reservation measure, and (iii) the second LSP record is associated with a second LSP that comprises the first link;
storing a third LSP record associated with the second protocol, wherein the third LSP record: (i) represents a fourth bandwidth reservation measure that is determined based on the second bandwidth reservation measure, and (iii) is associated with a third LSP that comprises the second link; and
determining a path associated with the second protocol based on the second LSP and the third LSP.

2. The method of claim 1, wherein the first protocol is a segment routing protocol.

3. The method of claim 1, wherein the second protocol is a Resource Reservation (RSVP) protocol or an RSVP with Traffic Engineering (RSVP-TE) protocol.

4. The method of claim 1, wherein determining the second LSP comprises:
determining that the first link is part of a fifth LSP, wherein the fifth LSP is associated with a third protocol and the third protocol is a second non-reservation routing protocol;
determining a fifth bandwidth reservation measure for the first link in relation to the third protocol; and
determining the first bandwidth reservation measure based on the first bandwidth reservation measure and the fifth bandwidth reservation measure.

5. The method of claim 1, wherein the second LSP is a one-hop LSP.

6. The method of claim 1, wherein storing the second LSP record comprises storing the second LSP record on a storage device associated with path computation element (PCE) associated with the second protocol.

7. The method of claim 1, wherein determining the path comprises determining the path using a PCE element associated with the second protocol.

8. The method of claim 7, wherein the PCE element determines the path based on receiving a PCE protocol request from a node in the network.

9. A system comprising:
one or more processors; and
one or more computer-readable media storing computer-executable instructions that, when executed by the one or more processors, cause the one or more processors to perform operations comprising:
identifying a first label-switched path (LSP) record associated with a first protocol, wherein: (i) the first protocol is a non-reservation routing protocol, and (ii) the first LSP record is associated with a first LSP that uses a first link and a second link in a network;
determining a first bandwidth reservation measure for the first link in relation to the first protocol;
determining a second bandwidth reservation measure for the second link in relation to the first protocol;
storing a second LSP record associated with a second protocol, wherein: (i) the second protocol is a reservation routing protocol, (ii) the second LSP record represents a third bandwidth reservation measure that is determined based on the first bandwidth reservation measure, and (iii) the second LSP record is associated with a second LSP that comprises the first link;
storing a third LSP record associated with the second protocol, wherein the third LSP record: (i) represents a represents a fourth bandwidth reservation measure that is determined based on the second bandwidth reservation measure, and (iii) is associated with a third LSP that comprises the second link; and
determining a path associated with the second protocol based on the second LSP and the third LSP.

10. The system of claim 9, wherein the first protocol is a segment routing protocol.

11. The system of claim 9, wherein the second protocol is a Resource Reservation (RSVP) protocol or an RSVP with Traffic Engineering (RSVP-TE) protocol.

12. The system of claim 9, wherein determining the second LSP comprises:
determining that the first link is part of a fifth LSP, wherein the fifth LSP is associated with a third protocol and the third protocol is a second non-reservation routing protocol;
determining a fifth bandwidth reservation measure for the first link in relation to the third protocol; and
determining the first bandwidth reservation measure based on the first bandwidth reservation measure and the fifth bandwidth reservation measure.

13. The system of claim 9, wherein the second LSP is a one-hop LSP.

14. The system of claim 9, wherein storing the second LSP record comprises storing the second LSP record on a storage device associated with path computation element (PCE) associated with the second protocol.

15. The system of claim 9, wherein determining the path comprises determining the path using a PCE element associated with the second protocol.

16. The system of claim 15, wherein the PCE element determines the path based on receiving a PCE protocol request from a node in the network.

17. One or more non-transitory computer-readable media storing computer-executable instructions that, when executed by one or more processors, cause the one or more processors to perform operations comprising:
one or more processors; and
one or more computer-readable media storing computer-executable instructions that, when executed by the one or more processors, cause the one or more processors to perform operations comprising:
identifying a first label-switched path (LSP) record associated with a first protocol, wherein: (i) the first protocol is a non-reservation routing protocol, and (ii) the first LSP record is associated with a first LSP that uses a first link and a second link in a network;
determining a first bandwidth reservation measure for the first link in relation to the first protocol;
determining a second bandwidth reservation measure for the second link in relation to the first protocol;
storing a second LSP record associated with a second protocol, wherein: (i) the second protocol is a reservation routing protocol, (ii) the second LSP record represents a third bandwidth reservation measure that is determined based on the first bandwidth reservation measure, and (iii) the second LSP record is associated with a second LSP that comprises the first link;
storing a third LSP record associated with the second protocol, wherein the third LSP record: (i) represents a represents a fourth bandwidth reservation measure that is determined based on the second bandwidth reservation measure, and (iii) is associated with a third LSP that comprises the second link; and
determining a path associated with the second protocol based on the second LSP and the third LSP.

18. The one or more non-transitory computer-readable media of claim 17, wherein the first protocol is a segment routing protocol.

19. The one or more non-transitory computer-readable media of claim 17, wherein the second protocol is a Resource Reservation (RSVP) protocol or an RSVP with Traffic Engineering (RSVP-TE) protocol.

20. The one or more non-transitory computer-readable media of claim 17, wherein determining the second LSP comprises:
determining that the first link is part of a fifth LSP, wherein the fifth LSP is associated with a third protocol and the third protocol is a second non-reservation routing protocol;
determining a fifth bandwidth reservation measure for the first link in relation to the third protocol; and
determining the first bandwidth reservation measure based on the first bandwidth reservation measure and the fifth bandwidth reservation measure.
